(19) United States
(12) Patent Application Publication
(10) Pub. No.: US 2019/0082122 A1
(43) Pub. Date: Mar. 14, 2019

(54) METHOD AND DEVICE FOR PROVIDING CONTEXTUAL INFORMATION

(71) Applicant: SAMSUNG ELECTRONICS CO., LTD., Suwon-si (KR)

(72) Inventors: Amitoj SINGH, Noida (IN); Prakhar AVASTHI, Noida (IN); Debayan MUKHERJEE, Noida (IN); Milan PATEL, Noida (IN); Subhav JAIN, Noida (IN); Manoj KUMAR, Noida (IN); Ranjesh VERMA, Noida (IN); Sourav CHATTERJEE, Noida (IN); Sambit PANDA, Noida (IN); Sanjeev BHATT, Noida (IN); Varad ARYA, Noida (IN); Veethika MISHRA, Noida (IN); Ridhi CHUGH, Noida (IN); Sherene KURUVILLA, Noida (IN); Amit Kumar SONI, Noida (IN); Shazia JAMAL, Noida (IN); Sabyasachi KUNDU, Noida (IN); Vishnupriya Surendranath KAULGUD, Noida (IN); Ritesh Ranjan SINGH, Noida (IN); Boski JAIN, Noida (IN); Saumitri CHOUDHURY, Noida (IN); Shivi PAL, Noida (IN); Suresh Kumar GARA, Noida (IN); Girish KULKARNI, Noida (IN); Sidhant GOYAL, Noida (IN); Vishal Bhushan JHA, Noida (IN)

(73) Assignee: SAMSUNG ELECTRONICS CO., LTD., Suwon-si (KR)

(21) Appl. No.: 16/124,394

(22) Filed: Sep. 7, 2018

(30) Foreign Application Priority Data
Sep. 8, 2017 (IN) 201711031903

(51) Int. Cl. H04N 5/272; G06F 17/30; H04N 5/232; H04W 4/20

(52) U.S. Cl. CPC H04N 5/272; G06F 17/3002; H04W 4/029; H04W 4/20; H04N 5/232939

(57) ABSTRACT

A method and a device for providing contextual information. The method includes detecting an invocation of a camera application via a user-input while executing a non-camera application by a device. The method further includes identifying content from one or more of a preview of the camera application and multi-media captured by the camera application. Further, the method includes identifying contextual information based on one or more of the identified content and information available from the non-camera application. Further, the method includes allowing the identified contextual information to be shared between the camera application and the non-camera application.

### CROSS-REFERENCE TO RELATED APPLICATION

This application is based on and claims priority under 35 U.S.C. § 119 to Indian Patent Application No. 201711031903, filed on Sep. 8, 2017, in the Indian Patent Office, the disclosure of which is incorporated by reference herein in its entirety.

### BACKGROUND

### 1. Field

The disclosure relates to a method of providing contextual information on a device, and a device thereof, and more particularly, to a method of launching a camera application to provide contextual services to a non-camera application.

### 2. Description of Related Art

With the increasing penetration of smart phones, easy availability and access to network infrastructure, and reduced prices of mobile data services, use of mobile data has proliferated over the years and is continuing to increase. As such, users are now able to access a wide range of services over applications, which are downloaded and installed on the smart phones. Examples of such applications include navigation applications, chat applications, mail applications, messaging applications, social media applications, imaging applications, video applications, music applications, and document processing applications. Some of these applications allow sharing or uploading media such as images, videos, audio, etc. The media may be prior—captured by the smartphones enabled with cameras using a camera application and thereafter stored as a media file on the smartphone to be shared or uploaded on the respective application.

Currently, the camera application is launched independently on the smartphones from the non-camera application. The independently launched camera application may enable providing contextual services onto an image captured by the camera application, as seen in the field of augmented reality. In one solution, it is possible to identify geographic location from an image captured by the camera application and provide contextual service such as geo-tagged location information on the captured image. However, such contextual services are only limited to the camera application.

Further, some solutions provide accessing a camera application while using messaging applications. When a camera application is invoked or accessed while using a messaging application, the user-interface on the device switches from an interface of the messaging application to a preview of the camera application. Thereafter, the camera application is used to select an image via a click. Upon selecting the image, the user-interface switches back to the original messaging application, and the selected image can be saved as an attachment. However, in such a solution, there is a limited use of content of the camera application i.e., a selected image, which can be used only for sharing purposes by the messaging application. Also, this solution is limited to messaging applications on a smartphone device and do not extend to other applications used on the smartphone device or applications on other devices. Thus, there exists a need for a solution that extends to other non-camera applications that are enabled to utilize the contextual services provided by a camera application.

The above information is presented as background information only to assist with an understanding of the present disclosure. No determination has been made, and no assertion is made, as to whether any of the above might be applicable as prior art with regard to the present disclosure.

### SUMMARY

In accordance with an aspect of the disclosure contextual services are shared between a camera application and a non-camera application in accordance with the requirements of each application.

Illustrative, non-limiting embodiments may overcome the above disadvantages and other disadvantages not described above. The disclosure is not necessarily required to overcome any of the disadvantages described above, and illustrative, non-limiting embodiments may not overcome any of the problems described above. The appended claims should be consulted to ascertain the true scope of an inventive concept.

According to an embodiment of the disclosure, a method providing contextual information is provided. The method includes detecting invocation of a camera application via a user-input while executing a non-camera application on a device and identifying content from at least one of a preview of the camera application, and multi-media captured from the camera application. The method further includes identifying contextual information based on at least one of the identified content, and information available from the non-camera application. Further, the method includes allowing the identified contextual information to be shared between the camera application and the non-camera application.

According to an embodiment of the disclosure, a device providing contextual information is provided. The device includes a detector to detect invocation of a camera application via a user-input while executing a non-camera application on the device. Further, the device includes a processor to identify content from at least one of: a preview of the camera application, and multi-media captured from the camera application. The processor further identifies contextual information based on at least one of: the identified content and information available from the non-camera application. The processor further provides that the identified contextual information is allowed to be shared between the camera application and the non-camera application.

In accordance with an aspect of the disclosure, but not limited thereto, a camera application is launched contextually from a non-camera application. The contextually launching of the camera application implies utilizing the context of the camera application by the non-camera application such that the camera-based context can be utilized during the services provided by the non-camera application. The camera-based context may be derived from a content of the camera application, the content being an image or a portion of an image being previewed on the camera application, or that has been captured by the camera application. The present disclosure extends to all form-of multi-media that can be captured or added to an image, using the camera application such as text-based multi-media, audio-video multi-media, graphical representations, stickers, location identifiers, augmented objects, virtual tags, etc. The camera-based context may also be derived from information available from a non-camera application based on the content of the camera application. For example, a geographic location corresponding to the content as detected by a location-based application or search-results corresponding to a product or object identified from the content, as detected by a search-application. The camera-based context shall be referred to as “contextual information” in the foregoing description according to embodiments of the disclosure. One aspect of launching the camera application contextually from the non-camera application is that the non-camera application is able to gather contextual information from different devices enabled with the contextually-launched camera application. The gathered contextual information can then be utilized by the non-camera application to provide augmented reality like services on other devices.

Some of further aspects of the disclosure also include sharing of the contextual information between the non-camera application and the camera application. This aspect enables supplementing the features of a camera application i.e., a live-preview of a camera application and an image being captured using the camera application, with contextual information as provided by the non-camera application. The contextual information as provided by the non-camera application may be based on augmented reality like services, modified content, virtual objects etc. Some more examples of contextual information being provided by the non-camera application to a camera application are location based services, augmented reality services such as pre-captured information including text-based multimedia, virtual objects, virtual tags, search-results, suggested nearby or popular locations, deals and suggestions, etc. All such contextual information corresponds to the live-content, or a content that has been captured by the camera application. The terms “live-content”, “preview”, and “live-preview” shall be interchangeably used in this document and shall refer to an image being viewed through the camera hardware of a device, prior to being captured.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a method of providing contextual information on a device according to an embodiment.

FIG. 2 is a block diagram illustrating a configuration of a device for providing contextual information according to an embodiment.

FIG. 3 is a block diagram illustrating a detailed configuration of a device for providing contextual information according to an embodiment.

FIGS. 4A-4E are views illustrating a user-interface of a device having a camera application being invoked and providing contextual information according to an embodiment.

FIGS. 5A-5D are views illustrating a user-interface of a device having a camera application being invoked and providing contextual information related to location according to an embodiment.

FIGS. 6A-6D are views illustrating a user interface of a device having a camera application being invoked and providing contextual information related to tagging according to an embodiment.

FIGS. 7A-7C are views illustrating a user interface of a device having a camera application being invoked and providing contextual information related to a location according to an embodiment.

FIGS. 8A-8C are views illustrating a user interface of a device having a camera application being invoked from another application according to an embodiment.

FIGS. 9A and 9B are views illustrating a user interface of a device having a camera application being invoked from yet another application according to an embodiment.

FIGS. 10A-10D are views illustrating a user interface of a device having contextual information related to contents in a camera application according to an embodiment.

FIGS. 11A-11B are views illustrating a user interface of a device having a camera application being invoked and providing contextual information related to tagging according to an embodiment.

FIGS. 12A-12B are views illustrating a user interface of a device having a camera application being invoked from a non-camera application to view contextual information related to a location associated with an object according to an embodiment.

FIGS. 13A-13D are views illustrating a user interface of a device having a camera application being invoked to view contextual information related to an object according to an embodiment.

FIGS. 14A-14C are views illustrating a user interface of a device having a camera application being invoked for a preview with contextual information according to an embodiment.

FIGS. 15A-15C are views illustrating a user interface of a device having a camera application being invoked from a search application according to an embodiment.

FIGS. 16A-16D are views illustrating a user interface of a device having a camera application being invoked from a calling application according to an embodiment.

FIG. 17 is a diagram illustrating hardware configuration of a computing device according to an embodiment.

### DETAILED DESCRIPTION OF EXEMPLARY EMBODIMENTS

It may be noted that to the extent possible, same reference numerals have been used to represent analogous elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding embodiments so as not to obscure the drawings with details that will be readily apparent to those of ordinary skill in the art having benefit of the description herein.

It should be understood at the outset that although illustrative implementations of embodiments are illustrated below, the disclosure may be implemented using any number of techniques, whether currently known or in existence. The disclosure should in no way be limited to the illustrative implementations, drawings, and techniques illustrated below, including exemplary design and implementation illustrated and described herein, but may be modified within the scope and spirit of the appended claims along with their equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more.” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illustrating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

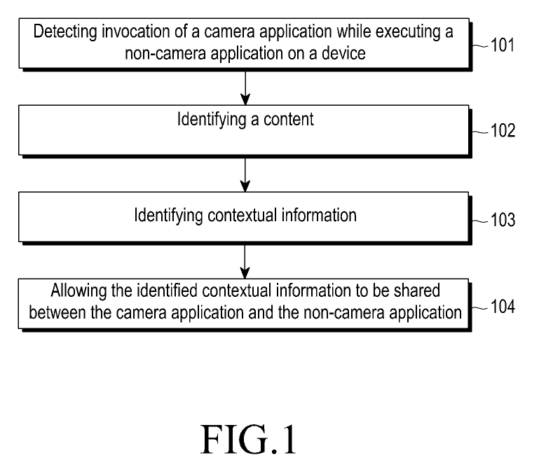

FIG. 1 is a flowchart illustrating a method of providing contextual information according to an exemplary embodiment. Referring to FIG. 1, the method includes detecting (operation 101), invocation of a camera application via a user-input while executing a non-camera application on a device. In an exemplary embodiment, the user-input is a gesture input received within the non-camera application. Further, the method includes identifying content (operation 102). The content is identified from a preview of the camera application. In one example, the preview of the camera application is a live surrounding view from camera hardware of the device. In another example, the preview of the camera application is an augmented reality view, or a virtual reality view enabled through the camera hardware of the device. In another exemplary embodiment, the content is identified from a multi-media captured by the camera application. The method further includes identifying contextual information based on at least of: the identified content and information available in the non-camera-application (operation 103). Then, the identified contextual information is shared between the camera application and the non-camera application (operation 104).

The camera application allows performing on the device, one or more of operations from a set of operations including a previewing operation, a multi-media capturing operation, and a location tagging operation. The set of operations also include various operations to be performed by the camera application for a virtual reality application and an augmented reality application. Such set of operations include a previewing operation in a respective virtual reality application and a respective augmented reality application, a respective virtual-object adding operation and a respective augmented multi-media adding operation and various other camera application related operations. By way of an example, the virtual-object adding operation can be adding a virtual emoji or a virtual tag on an image, using the services of the camera application. In an exemplary embodiment, the camera application is configured to operate as an omni-directional camera where the set of operations allowed to be performed on the device include a previewing operation and a multi-media capturing operation in an omni-directional view.

In accordance with an exemplary embodiment, the camera application allows performing one or more operations from the set of operations as disclosed above, when invoked from the non-camera application on the device. In one such example, the camera application is invoked within the non-camera application to perform a previewing operation, a multi-media capturing operation, and a location tagging operation, as explained above by way of an example. Once an operation is performed by the camera application within the non-camera application, content is identified from at least one of a preview of the camera application and multi-media captured from the camera application. In one example, the content being identified refers to an image or a portion of an image that is either being live-previewed or, that has been captured from the camera application. In another example, the content being identified refers to textual information, a multi-media object, a virtual object, or an augmented object, a location tagged-data, also referred to as “geo-tagged data”, including location identifiers, location-based multi-media objects, location-based virtual object, location-based textual information etc., resulting from a respective adding operation or a location tagging operation performed on an image being previewed or as captured by the camera application.

In accordance with an exemplary embodiment, the contextual information identified based on the content of the camera application is shared with the non-camera application. In an exemplary embodiment, the contextual information based on the content includes captured multi-media, an added virtual object, augmented multi-media, and a location tagged data, as explained above by way of an example. Also, by way of an example, the contextual information is a graphical representation of location identifiers, textual multi-media, stickers, symbols, and any other form of geo-tagged multi-media. By way of another example, the contextual information is a suggested location or recommendations represented by the captured multi-media at a particular location. By way of another example, the contextual information is a business logo, and or details of a business-related service at a particular site. Such contextual-information can be shared with the non-camera application as a live-information, in real-time according to an example embodiment.

Further, according to an exemplary embodiment, the method may provide the contextual information based on the identified content at one or more designated positions on the non-camera application. In an exemplary embodiment, the contextual information is overlaid or superimposed at the designated positions in the non-camera application. In yet another exemplary embodiment, the method includes overlaying the contextual information on a preview in the camera application, the camera application being invoked from the non-camera application running on the device. In one such example, the preview in the camera application can be a surrounding view, an omni-directional camera view, an augmented reality view, or a virtual reality view. In yet another exemplary embodiment, the method includes overlaying the contextual information on a multi-media captured by the camera application, the camera application being invoked from the non-camera application running on the device.

In accordance with another exemplary embodiment, the method includes storing the contextual information based on the identified content, in a database for use in augmented reality applications on other devices. In another exemplary embodiment, the contextual information, as stored in the database, is provided to the other devices while executing on the respective other device, a camera application, a camera application invoked from a non-camera application and/or an augmented reality application. In yet another exemplary embodiment, the method includes authenticating other devices prior to providing the contextual information. The authentication can be based on one or more known methods in a field of sharing electronic information (contents) amongst devices.

In accordance with yet another exemplary embodiment, the contextual information is identified based on the information available in the non-camera application. Further, such information that is available in the non-camera application corresponds to at least the content identified from the camera application. According to an exemplary embodiment, the contextual information based on the information available in the non-camera application is communicated to the camera application of the device, from a server of the non-camera application. According to another exemplary embodiment, the contextual information based on the information available in the non-camera application is communicated to camera application of the device, from another device that is enabled with a camera application, or a camera application invoked from a non-camera application, in accordance with exemplary embodiments. According to yet another exemplary embodiment, the contextual information based on the information available in the non-camera application is communicated to the camera application of the device, from the database as discussed above. Such database stores contextual information based on the content from one or more devices. The contextual information is further mapped to information available in the non-camera application.

In one exemplary embodiment, the information is a geographic location identified for the content. According to an exemplary embodiment, the non-camera application is an application configured to provide information of the identified geographic location, for example, a navigation application, or a location-based application configured to provide information of the geographic location as received from the location detecting settings of the device. In case of a smartphone, the location detecting settings can be a global-positioning system enabled in the device. According to yet another exemplary embodiment, the non-camera application is an application configured to retrieve geographic location from a pre-stored database that includes a mapping of the content, or a meta-data retrieved from the content, to a specific geographic location. By way of an example, the pre-stored database may be same as the database disclosed above, and/or may be located at the server of the non-camera application.

In accordance with an exemplary embodiment, the information is a geographic location identified from the content, the contextual information provided by the non-camera application to a camera application includes one or more pre-captured multi-media including images, textual-information, location identifying data, a pre-designated augmented multi-media or a pre-designated virtual object including graphical objects, virtual tags, symbols, one or more suggested locations, one or more geo-tagged data, etc. By way of an example, the pre-captured multimedia can be a pre-captured image or a pre-captured video that had been captured at the same location, or a proximately nearby location to the geographic location as identified from the content of the camera application.

In accordance with a further exemplary embodiment, the method includes providing the contextual information based on a geographic location as identified from the content, in the camera application in a rank-based manner. In one exemplary embodiment, when the camera application is being invoked from a non-camera application such as a navigation application, the contextual information is provided in the camera application based on a rank of the contextual information, the rank being in relation to a distance range measured from the device. The distance range may correspond to a navigation speed of the device according to an exemplary embodiment. The foregoing description of the device includes further details of the ranking of such contextual information.

In another exemplary embodiment, the information is a product or an object identified from the content. According to an exemplary embodiment, the image or a portion of the image, that is being previewed or has been captured by the camera application, is analyzed to retrieve meta-data. The meta-data describes, or is mapped, to specific objects or products. Accordingly, the contextual information available from the non-camera application is in relation to such object or products. In one exemplary embodiment, the non-camera application is an e-commerce application. The contextual information based on the information available from the e-commerce application includes, one or more recommended products based on one or more products identified from the content, one or more pricing information associated with the one or more recommended products, suggested locations, for-example, a suggested store location to visit and purchase same or similar products, etc.

In accordance with another exemplary embodiment, the contextual information being provided by an e-commerce application to the camera application includes modified content, or an augmented view, or a virtual image, based on the content of the camera application. In one example, the contextual information includes modified content. The modified content may be dynamically updated based on one or more auto performed action(s) on the content. In one example, the auto-performed action includes swapping a portion of an image from the camera application with another image. The auto-performed action may be a result of receiving a user selection of a portion of the image. The user-selected portion may be a portion of the image which the user wants to be modified with contextual information from the e-commerce application. Herein, the contextual information includes the other image, including multi-media, virtual objects, etc. that is swapped with the portion of the original image. Alternatively, the image or a portion of the image may be analyzed to determine a modifiable portion and the modifiable portion is swapped with the contextual information from the non-camera application. The contextual information thus provided is a modified content including a swapped portion within the user-selected portion or the modifiable portion, in the original content. In another example, the auto-performed action includes swapping a portion of an image being previewed, or captured, from a rear-view of the camera application with a portion of an image being previewed, or captured from a front-view of the camera application. Further, the auto-performed action includes activating both the front camera and the rear camera on the device for performing such swapping action. The contextual information thus provided is modified content including a swapped portion of the rear-view of the camera application with a front-view of the camera application.

According to an exemplary embodiment, the contextual information includes modified content including virtual mannequins wearing a product or an object being previewed or captured by the camera application. The modified content may be dynamically updated based on one or more auto performed action(s) on the modified content, i.e., on the virtual mannequins. One or more actions can be further auto-performed on the virtual mannequins according to various user-selections received from the device. In one specific example, the auto-performed action includes adding virtual objects or graphical products to the virtual mannequins based on corresponding user-selections made using the device. Such contextually processed features when provided by an e-commerce application on a camera application, assists the users in e-shopping by virtually experimenting with the virtual mannequins.

In accordance with a further exemplary embodiment, the contextual information being provided by a search-based, or a searching application, includes one or more search results including multi-media or textual information pertaining to substantially similar products in relation to the one or more products thus identified from the content. In an exemplary embodiment, the non-camera application is a search application, the contextual information can also include contextual information similar to those identified for an e-commerce application. Such similar contextual information includes modified content, or an augmented view, based on the content of the camera application. In one example, the modified content of the camera application includes contextual information i.e., the search results overlaid on the original content of the camera application.

In accordance with an exemplary embodiment, the contextual information being shared between the camera application and the non-camera application is the content as identified from the camera application. The content being shared is an image or a portion of image that is being previewed or has been captured by the camera application. The preview of the camera application can include a front preview and a rear preview of the camera of the device. In an exemplary embodiment, the contextual information is provided within the non-camera application during an active session of the respective non-camera application on the device. In one example, the non-camera application is a calling application and the contextual information is provided during an ongoing calling operation on the device. Herein, the calling operation is being initiated on the device by the respective calling application. In another example, the non-camera application is a texting application or a chat application, and the contextual information is provided during a respective ongoing texting session or a respective ongoing chat session on the device. In yet another example, the non-camera application is a media application such as a music application or a video playing application. The contextual information is provided during a respective ongoing music play or a respective ongoing video play on the device.

In accordance with an exemplary embodiment, the contextual information being shared with the non-camera application is the content identified from the camera application. The method includes providing a user-interface within the non-camera application. The user-interface includes a plurality of user-actionable items. Each of the plurality of user actionable items auto-performs an operation based on the content as identified from the camera application. According to one implementation, the plurality of user actionable items includes a content sharing action and/or a content searching action. By way of an example, the content being identified from the preview of the camera application or a multi-media captured from the camera application, can be shared by selecting the content sharing action on the device, with another device. In one exemplary embodiment, the method includes authenticating another device before proceeding to share the content with another device. By way of another example, the content being identified from the preview of the camera application or a multi-media captured from the camera application, can be auto-searched by the non-camera application by selecting the content searching action. In one exemplary embodiment, the non-camera application is a searching application or an e-commerce application, or any other similar application capable of providing search results. In an exemplary embodiment, the non-camera application does not include search functionality, the content can be auto-shared with a searching application to provide search results.

Further, according to an exemplary embodiment, the method includes providing the contextual information within a preview of the camera application or the multi-media as captured by the camera application, when the camera application is invoked on the device, while executing a non-camera application on the device. According to an exemplary embodiment, the contextual information is provided within a preview of the camera application or the multi-media as captured by the camera application. The camera application is being invoked from or over the non-camera application on the device. In an exemplary embodiment, the contextual information is provided within a preview of the camera application or the multi-media as captured by the camera application, even when the camera application is launched independently on the device. The contextual information can be retrieved from a memory of the device that has pre-stored a list of contextual information for a corresponding content of the camera application, or through communication with a server of the non-camera application.

According to an exemplary embodiment, the contextual information as provided by the non-camera application to a camera application is overlaid on the content of the camera application, at one or more pre-designated positions. The pre-designated positions correspond to the actual geographic location as identified from the content of the camera application. The pre-designated positions can include exact locations or nearby proximate locations.

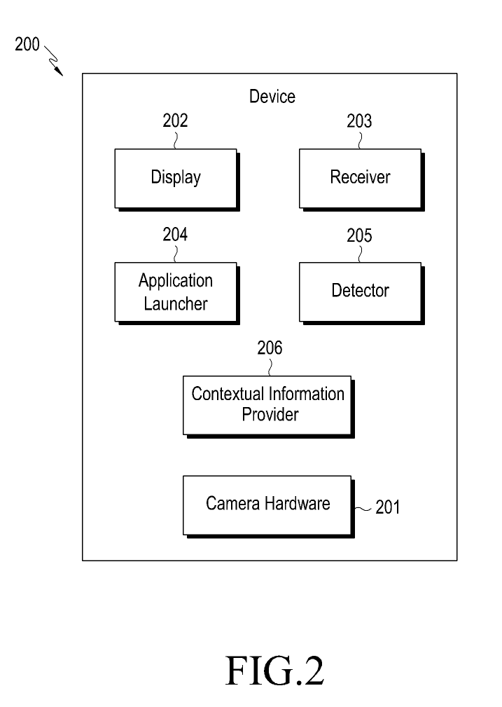

FIG. 2 is a block diagram illustrating a device providing contextual information according to an exemplary embodiment. The device 200 includes a camera hardware 201 enabled with a camera application installed in the device 200. In an exemplary embodiment, the camera hardware 201 is enabled with an augmented reality application or a virtual reality application running on the device 200 which performs one or more operations from a set of operations similar to those of the camera application on the device 200. Examples of the device 200 include a smart phone, a laptop, a tablet, and a Personal Digital Assistance (PDA). These are provided by way of an example and not by way of a limitation. Further, as illustrated in FIG. 2, the device 200 includes a display 202 which displays a user-interface providing various features of the device 200 and providing various applications available on the device 200. In accordance with an exemplary embodiment, the display 202 displays the camera application within a non-camera application, the camera application being invoked while executing the non-camera application on the device 200. The device 200 further includes a receiver 203 configured to receive user-input on the device 200. In an exemplary embodiment, the receiver 203 is configured to receive user-input within the non-camera application to invoke a camera application. According to an exemplary embodiment, the user-input to invoke the camera application on the device 200 is a gesture input. The gesture input includes, but not limited to, a rail-bezel swipe on the device 200, a double tap, a five finger swipe etc. In an exemplary embodiment, the receiver may be a touch screen of the device 200 and sensors which sense the user input on the touch screen of the device 200.

Further, the device 200 includes an application launcher 204 configured to launch an application on the device 200. Upon receiving the user-input on the device 200 to invoke the camera application while executing the non-camera application on the device 200, the application launcher 204 launches or invokes the camera application within the non-camera application. The application launcher is software such as an operating system (OS) executable by a hardware processor, according to an exemplary embodiment.

The device 200 further includes a detector 205 configured to detect invocation of a camera application via a user-input on the device 200, while executing a non-camera application. Further, the device 200 includes a contextual information provider 206 configured to identify contextual information according to various exemplary embodiments. According to one exemplary embodiment, the contextual information provider 206 may apply image processing techniques or other known media analyzing techniques including optical character recognition (OCR) to identify content from the preview of the camera application, or multi-media captured from the captured application. In another exemplary embodiment, the contextual information provider 206 may include a content analyzer (not shown) to identify content from the camera application. Further, the contextual information provider 206 is configured to allow the contextual information to be shared between the camera application and the non-camera application. In an exemplary embodiment, the contextual information provider 206 is configured to provide the contextual information within the non-camera application on the device 200. In an exemplary embodiment, the contextual information provider 206 is configured to provide the contextual information within the camera application, the camera application being invoked over the non-camera application on the device 200. According to an exemplary embodiment, the detector 205 and the contextual information provider 206 is software and/or instructions executed by a hardware processor.

Further, the contextual information provider 206 is configured to provide a user-interface including a plurality of user actionable items in the non-camera application.

Further, the contextual information provider 206 is configured to communicate with the application launcher 204 to launch one or more applications in accordance with exemplary embodiments. By way of an example, on detecting content, the contextual information provider 206 communicates a search application launching request to the application launcher 204.

It should be understood that the various components or units as described above may be incorporated as separate components on the device 200 or as a single component or as one and more components on the device 200 as necessary for implementing exemplary embodiments. In one aspect of exemplary embodiments, the detector 205 and the contextual information provider 206 can be implemented as a different entity as depicted in the figure. In yet another aspect of an exemplary embodiment, the contextual information provider 206 can be implemented in a remote device such as a server (not shown) separate from the device 200 and can be configured to receive communication regarding invocation of the camera application from the detector 205 on the device (200).

Furthermore, the contextual information provider 206 and the detector 205 can be implemented as a hardware, software modules or a combination of hardware and software modules, according to an exemplary embodiment. Further, the input receiver 203 and the application launcher 204 can be implemented as hardware, software modules, or a combination of hardware and software modules.

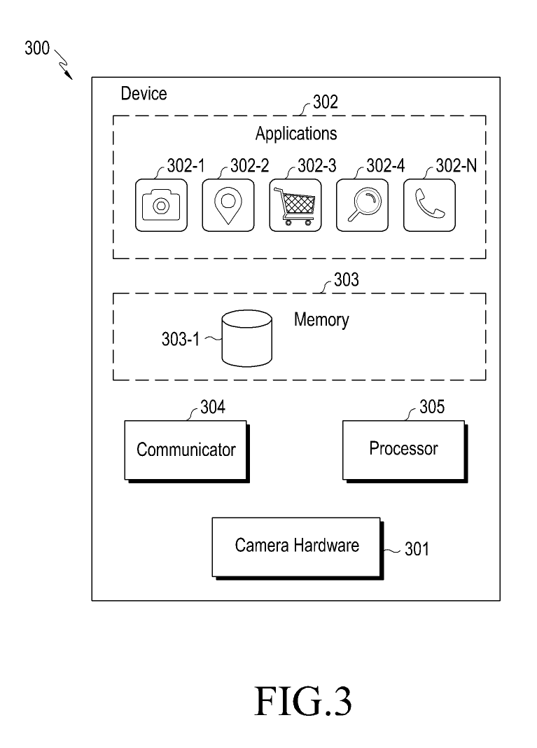

FIG. 3 is a block diagram illustrating a detailed configuration of a device 300 having camera hardware 301, including various other components in accordance with various exemplary embodiments. The device 300 includes one or more applications 302-1, 302-2, 302-3, 302-4, . . . 302-N (hereinafter referred to as application 302 indicating one application and applications 302 indicating two or more applications). The applications 302 include at least one camera application (hereinafter referred to as 302-1) and one non-camera application (hereinafter referred to as 302-2). Examples of such non-camera applications 302-2 include, but not limited to, a navigation application, a location-based application, an e-commerce application, a searching application, a music playing application, a music-video playing application, a calling application, a chat applications, image-sharing applications, and social networking applications. In addition to these applications, various other applications are inherently provided in the device 300 by a manufacturer of the device 300. Examples of such applications include, but not limited to, image/video capturing application such as the camera application 302-1, image/video viewing application such as gallery, messaging application for sending and receiving messages such as short messaging service (SMS) and multimedia messaging service (MMS), and a calling application to make voice and/or video calls based on the cellular network accessible by the device 300 and data network accessible by the device 300.

The device 300 includes a memory 303 to store information related to the device 300. The memory 303 includes a contextual information database 303-1 in communication with the contextual information provider 206, as shown in FIG. 2. In an alternative exemplary embodiment, the contextual information database 302-1 can be external to the device 300. According to a further exemplary embodiment, the contextual information is received by the device 300 from a contextual information database 303-1 residing at a remote server (not shown). In an exemplary embodiment, the contextual information database 303-1 includes contextual information mapped to content as identified from the camera application 302-1. In another exemplary embodiment, the contextual information database 303-1 includes contextual information mapped to information available from the non-camera application 302-2 and a corresponding content, or a meta-data of the content, as identified from the camera application 302-1. Further, the contextual information database 303-1 is configured to receive data entries from the device 300 and the remote server. In one example, the contextual information database 303-1 receives contextual information as data entries resulting from one or more operations from the set of operation performed by the camera application 302-1 being invoked by the non-camera application 302-2. In another example, the contextual information database 303-1 receives contextual information as data entries resulting from one or more operations from the set of operation performed by the camera application 302-1 on the device 300 while executing the camera application 303-1 on the device 300 as a standalone application. In yet another example, the contextual information database 303-1 receives contextual information as data entries resulting from one or more operations from the set of operation performed by the camera application 302-1 on the device 300 while executing an augmented reality application or a virtual reality application which provide functionalities to add augmented or virtual objects on image being viewed or captured by the camera hardware 301.

According to another exemplary embodiment, the contextual information database 303-1 receives contextual information as data entries resulting from one or more operations from a set of operations, similar to those performed by the camera application 302-1 on the device (300), as performed on other devices. The other devices include smartphones, electronic devices configured with camera hardware 301 and camera functionalities enabled thereon, virtual reality devices, augmented reality devices, and similar other devices. In another exemplary embodiment, the contextual information database 303-1 receives contextual information as data entries based on a received communication by the device 300 from the remote server.

According to yet another exemplary embodiment, the contextual information and/or other data entries in the contextual information database 303-1 is shared with the other devices or the remote server. The device and the other device may include appropriate software capabilities, integrated to the device 300 or downloaded on the device 300, to authenticate each other prior to sharing the contextual information. Examples of the authentication techniques include PIN authentication technique, password authentication technique, etc. In one example, the contextual information is shared for the purpose of augmented reality applications on other devices.

According to yet another exemplary embodiment, the contextual information database 303-1 includes a corresponding rank of the contextual information. In accordance with an exemplary embodiment, the ranks are dynamically assigned to the contextual information by the contextual information provider 206 shown in FIG. 2. According to an exemplary embodiment, the corresponding ranks that are assigned to the contextual information are in relation to a distance range measured from the device 300. Further, the distance range corresponds to a navigation speed of the device 300. As explained above, a navigation application provides the navigation speed of the device at a given point of time. Accordingly, the ranks are dynamically updated or changed in the contextual information database 303-1 based on the navigation speed of the device 300 at a given point of time. Further, the contextual information as provided to the device 300 are dynamically updated or changed based on their rank. By way of an example, the contextual information based on a geographic location as detected from the content are ranked higher in terms of the distance range measured from the device 300. Such ranking are in relation to a corresponding navigation speed of the device 300 as described in a following table, according to an exemplary embodiment:

| | Ranking based on |
|---|---|
| Navigation Speed | the Distance Range |
| Greater than 30 Km/hour: For example, | Contextual information up to |
| during driving by the user of the | 1000 meters is to be provided |
| device 300. | on the device 300. |
| Greater than 20 Km/hour and Less than 30 | Contextual information up to |
| Km/hour: For example, during running | 1000 meters is to be provided |
| by the user of the device 300. | on the device 300. |
| Greater than 10 Km/hour and Less than 20 | Contextual information up to |
| Km/hour: For example, during walking | 750 meters is to be provided |
| by the user of the device 300. | on the device 300. |
| Less than 10 Km/hour: For example, | Contextual information up to |
| when the device (300) is static. | 500 meters is to be provided |
| | on the device 300. |

The device 300 further includes a communicator 304 to communicate, share, and receive contextual information from the remote server and other devices.

The device 300 may further include a processor 305 to perform one or more processes on the device 300 in relation to one or more user-input received on the user-actionable items as provided on the user-interface of the non-camera application.

It should be understood that the various components or units as described above may be incorporated as separate components on the device 300, or as a single component, or as one and more components on the device 300 as necessary for implementing exemplary embodiments. In one aspect of exemplary embodiments, the detector 205 and the contextual information provider 206, as shown in FIG. 2, can be implemented as forming part of the processor 305. Furthermore, in one aspect of exemplary embodiments, the receiver 203 and the application launcher 204, as shown in FIG. 2, can be implemented as forming a part of the processor 307. In one further aspect of an exemplary embodiment, the contextual information provider 206, the detector 205, the application launcher 204, as shown in FIG. 2, form part of the memory 303.

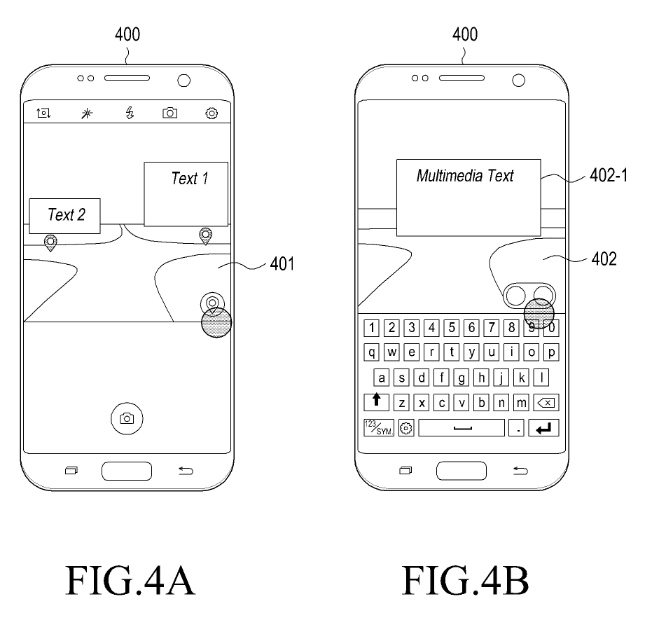

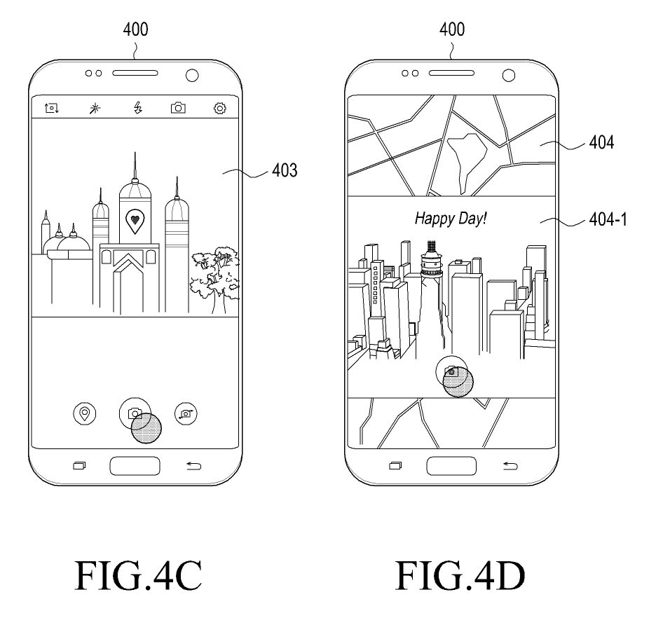

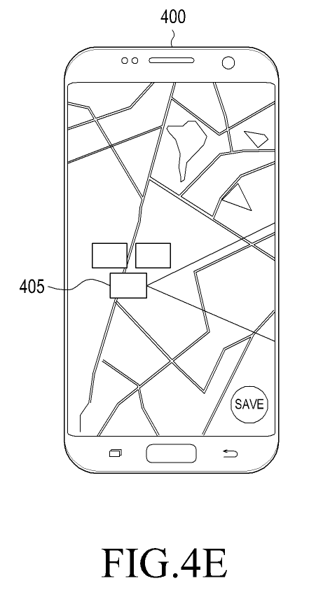

FIGS. 4-16 are views illustrating various exemplary embodiments. Some of the additional exemplary embodiments shall also become apparent through the description of FIGS. 4-16. Further, it should be noted that although a preview of the camera application has been used in the illustrations, a multi-media clicked such an image clicked by the camera application can also replace a preview of the camera application, without departing from the scope and spirit of the disclosure. However, it may be strictly understood that the forthcoming examples shall not be construed as being limitations towards the disclosure and may be extended to cover analogous exemplary through other type of like mechanisms.

FIGS. 4A-4D are views illustrating a user-interface of a device 400 depicting exemplary screenshots of a camera application being invoked on the device 400, according to an exemplary embodiment. In FIG. 4A, a user-interface 401 corresponding to the camera application is displayed on the device 400. The user-interface 401 represents a screenshot of the camera application including contextual information. The contextual information as represented in FIG. 4A is in the form of text or text-based multi-media, and location identifiers resulting from a respective adding operation or a location-tagging operation on an image being previewed or captured by the camera application.

By way of an example, the user can add comments about a particular place that he has visited by capturing multi-media at a particular location or using location tagging operation of the camera application on his device 400. As shown in FIG. 4B, a user-interface 402 of the device 400 is depicted which represents a screenshot of the camera application including a text or a comment adding portion 402-1 while using an adding-operation or a location tagging operation of the camera application on the device 400. Further, the contextual information based on the content of the camera application i.e., the location-tagged comment or text-based multi-media shall be saved for future viewing with the camera application. Thus, when the same location is viewed again with the camera application, the users shall be able to view the pre-captured multi-media at the same location. Referring to FIG. 4C, a user-interface 403 depicts an exemplary screenshot of the camera application displayed on the device 400 representing a location-tagged sticker as contextual information appearing for a particular location, while viewing the location using the camera application.

By way of a further example, a method according to an exemplary embodiment can be used to provide search service in a navigation application where the search service includes connecting to journals created by other users. The journals are created by launching the camera application over the navigation application or from the navigation application. Referring to FIG. 4D, a user-interface 404 displays an exemplary screenshot of the camera application being invoked from a navigation application on the device 400. The screenshot represents a geo-sticker 404-1 being added from the camera application to the navigation application. The geo-sticker being added appears on a screen of the navigation application designated to a particular location. While a user of the navigation application views a particular route on that navigation application, the geo-stickers pre-captured for particular locations appear on screens of his navigation application. Referring to FIG. 4E, the user-interface 405 depicts an exemplary screenshot of the navigation application displayed on the device 400 representing the saved geo-stickers for particular locations. The users of the navigation application while viewing the location-tagged information, for-example, the geo-stickers can view and like the geo-stickers. These geo-stickers can be time-bound i.e., if they do not receive sufficient views or likes, they perish or disappear.

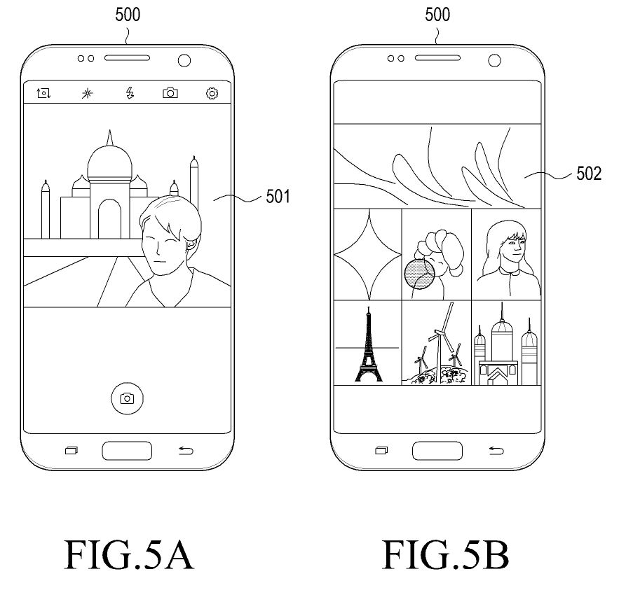

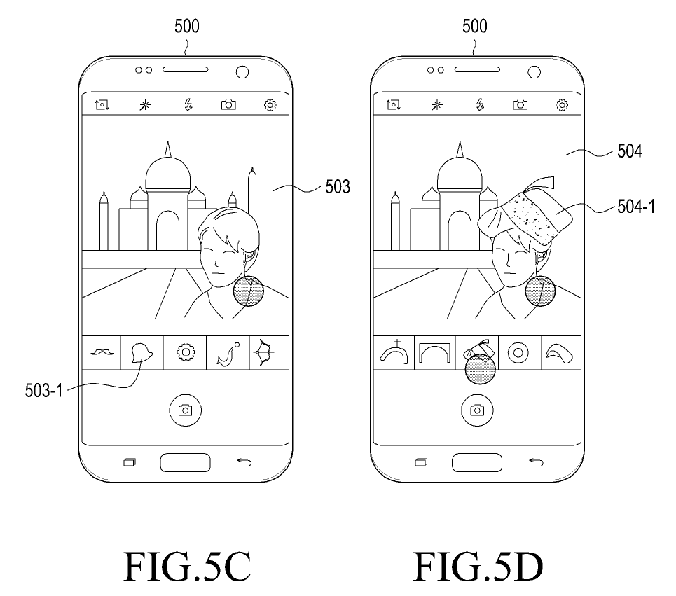

FIGS. 5A-5D are views illustrating a user-interface of a device 500 depicting exemplary screenshots of a camera application being invoked on the device 500, according to an exemplary embodiment. These screenshots represent contextual-information including location-based stickers to be shared with the camera application. By way of an example, the location based stickers, made available at public spots, are resulting from pre-captured multi-media by different users of the camera application on their respective devices who have captured images at the respective geographic locations identifying the place. Referring to FIG. 5A, the user-interface 501 of the device 500 depicts a front-preview of the camera application on the device 500. Referring to, FIG. 5B, a user-interface 502 of the device 500 depicts a screenshot representing geo-stickers available in an image gallery. Referring to FIG. 5C, a user-interface 503 of the device 500 depicts a screenshot representing geo-stickers available on a user-interface 503-1 shown within the user-interface 503. Referring to FIG. 5D, a user-interface 504 of the device 500 depicts a screenshot representing a front-preview of the camera application with a geo-sticker 504-1 as selected by the user.

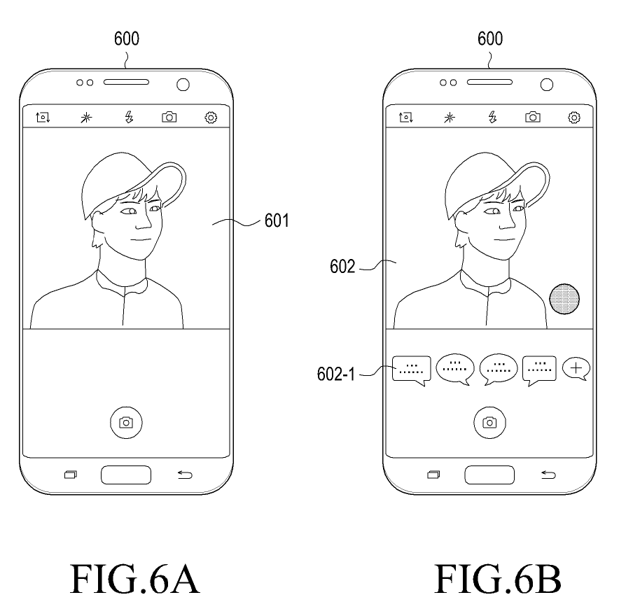

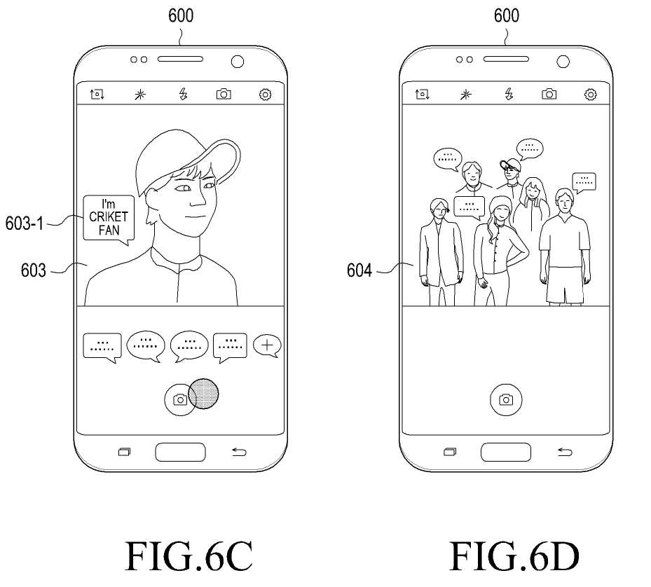

FIGS. 6A-6D are views illustrating a corresponding user-interface of a device 600 depicting exemplary screenshots of a camera application being invoked on the device 600 according to an exemplary embodiment. The screenshots represent contextual-information including self-tagged stickers to be shared with the camera application. By way of an example, self-tagging is provided where a user previewing oneself on a screen of the camera application running on the device 600 can tag himself using a location-based sticker or any other form of multi-media. Once tagged, other people viewing the same user on their respective camera applications will be able to view the user along with his self-tagged information similar to an augmented reality view. Referring to FIG. 6A, a user-interface 601 of the device 600 depicts a screenshot of a front preview of the camera application. Referring to FIG. 6B, a user-interface 602 of the device 600 depicts a screenshot of a front preview of the camera application and a list of stickers or multi-media 602-1 to be added to the front-preview of the camera application. Referring to FIG. 6C, a user-interface 603 of the device 600 depicts a screenshot of a front preview of the camera application including a sticker 603-1 as self-tagged information selected by the user. Referring to FIG. 6D, a user-interface 603 of the device 600 depicts a screenshot of a preview of the camera application where the users appearing on the preview image have their respective self-tagged information.

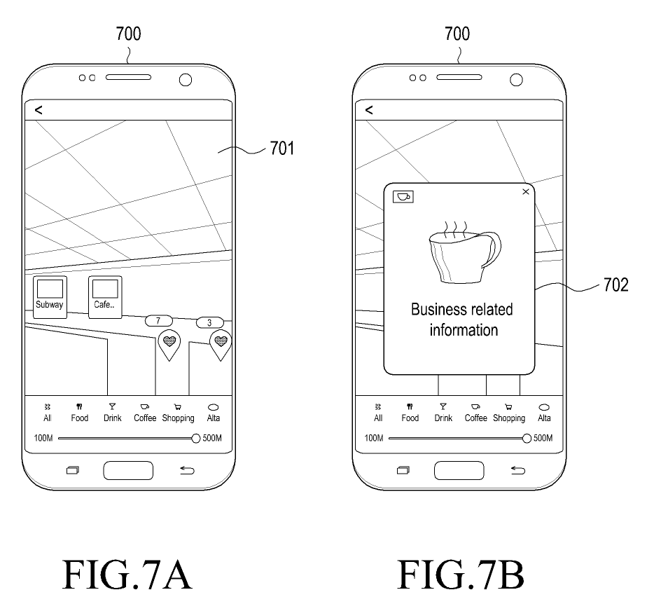

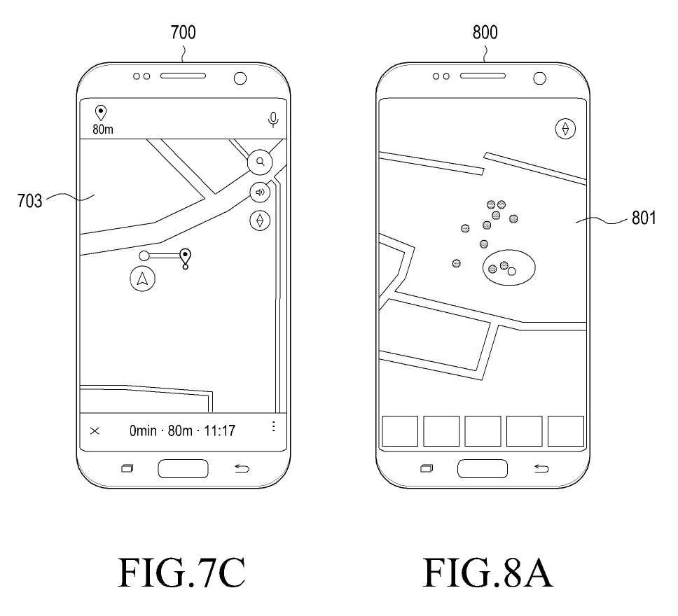

FIGS. 7A-7C are views illustrating a corresponding user-interface of a device 700 depicting exemplary screenshots of a camera application being invoked on the device 700 according to an exemplary embodiment. The screenshots represent contextual-information including location tagged information of nearby-places being provided on the camera application at designated places. By way of an example, the nearby places are displayed under all categories similar to an augmented reality view. Referring to FIG. 7A, a user interface 701 of the device 700 depicts a screenshot of a preview of the camera application where the location tagged information represented as location identifying stickers of nearby places appear at the designated places. Referring to FIG. 7B, a user-interface 702 of the device 700 depicts a screenshot of the camera application where a business-specific logo along with details of a particular location appears on the camera application when a user selects the location identifying sticker of that particular location. By way of an example, a user can select the business-specific logo to view navigation directions to that particular business site on a navigation application. Referring to FIG. 7C, a user-interface 703 of the device 700 depicts a screen shot of a navigation application showing directions on how to reach that business location.

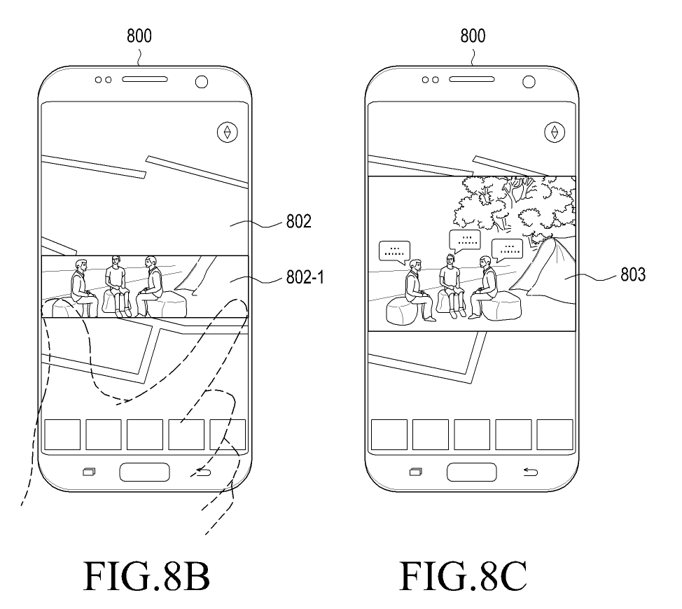

FIGS. 8A-8C are views illustrating a corresponding user-interface of a device 800 depicting exemplary screenshots of a camera application being invoked from a non-camera application on the device 800 according to an exemplary embodiment. The screenshots represent contextual-information based on the content of the camera application. By way of an example, when a camera application is invoked from a non-camera application, self-tagged information, as provided by users who allow themselves to be viewed on the navigation application, appear within a preview of the camera application being invoked within the navigation application. This application is similar to an augmented reality based service of the camera application, in accordance with exemplary embodiments. Further, the camera application being invoked within the non-camera application, allow users to find other users who have tagged themselves and are willing to socially interact. Referring to FIG. 8A, a user-interface 801 of the device 800 depicts a screenshot of a navigation application. The user can select at a portion of a screen of the navigation application on the device 800 where the user wants to view other users. Referring to FIG. 8B, a user-interface 802 of the device 800 depicts a screenshot of a camera application being invoked from or over the navigation application resulting from a bezel-swipe within the navigation application. The camera application as represented shows a live-preview 802-1 including users present at that particular location where the camera application has been invoked. The particular location being a location displayed on a screen of the navigation application. Referring to FIG. 8C, a user-interface 803 of the device 800 depicts a screenshot of a live-preview of the camera application including virtual tags or self-tagged information of the users present at the locations within the live-preview of the camera application.

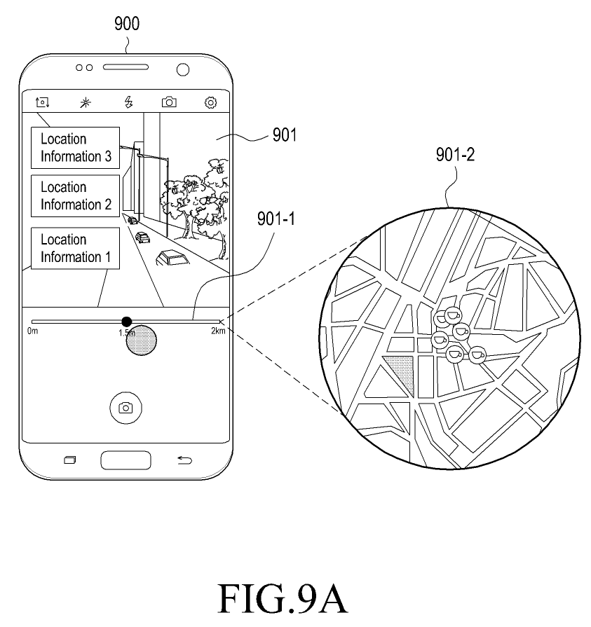

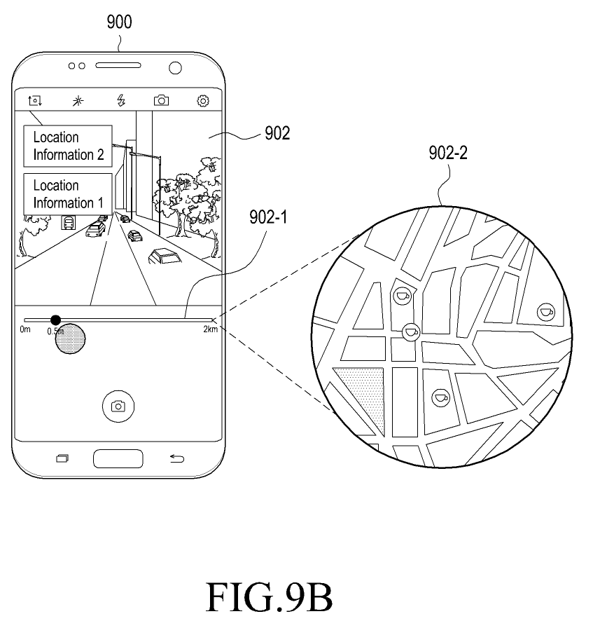

FIGS. 9A and 9B are views illustrating a corresponding user-interface of a device 900 depicting exemplary screenshots of a camera application being invoked from a non-camera application on the device 900 according to an exemplary embodiment. The screenshots represent contextual-information based on the content of the camera application. By way of an example, when a camera application is invoked from a navigation application, contextual services can be provided by the camera application to the navigation application when camera application is invoked within the navigation application. By way of a further example, while viewing the camera application from the non-camera application, location-based tags or information can be viewed within a preview of the camera application where the range of the view can be set by the user. Referring to FIG. 9A, a user-interface 901 of the device 900 depicts a screenshot of a camera application being invoked over a navigation application where contextual information in the form of location based information appears within a preview of the camera application. Within the user-interface 900, a view rage setting control 901-1 is provided which the user can click and drag on in the left-right direction to zoom out and zoom-in respectively into the preview. A bubble 901-2 shows a specific zoom-out view of the navigation application based on the user-selected range on the range setting control 901-1. Referring to FIG. 9B, a user-interface 902 of the device 900 depicts a screenshot of a camera application being invoked from a navigation application, with a view range setting control 902-1 being provided within the preview of the camera application which the user can click and drag on in the left-right direction to zoom out and zoom-in respectively into the preview. A bubble 902-2 shows a specific zoom-in view of the navigation application based on the user-selected range on the range setting control 902-1.

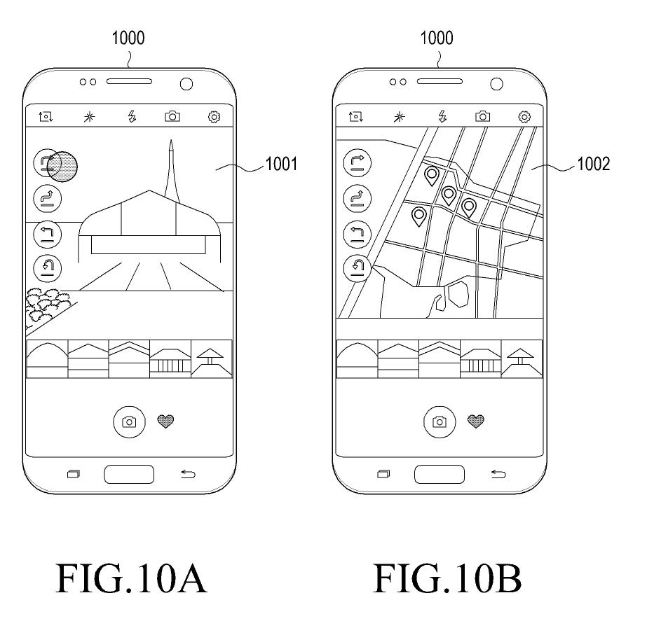

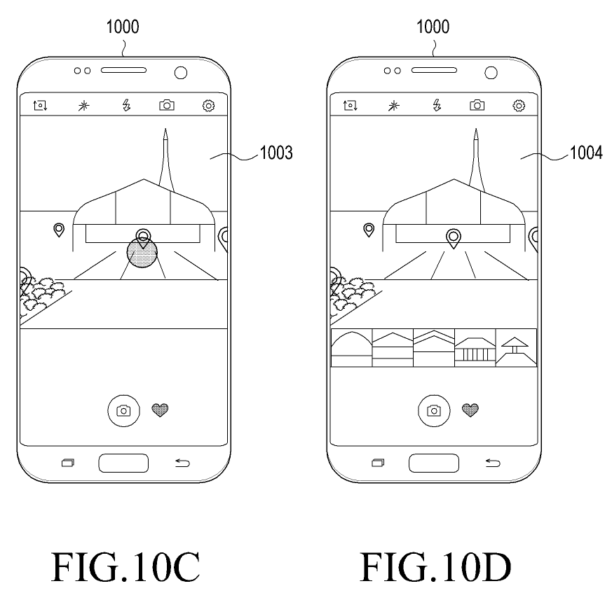

FIGS. 10A-10D are views illustrating captured multi-media of a particular location appearing as location tagged information on a screen of a camera application while previewing the same location according to an exemplary embodiment. The camera application may allow alternate views to view virtual tagged information by other users in the same location and also reference images which have been captured in the same location. Some of the virtual tagged information may indicate most visited or most liked spots at a particular location. Referring to FIG. 10A, a user interface 1001 of the device 1000 depicts a screenshot of a camera application representing an image along with a reel of images that have been captured at a particular location. Referring to FIG. 10B, a user interface 1002 of the device 1000 depicts a screenshot of a navigation application representing most visited location or a favorite location where most of the images have been captured. The user interface 1002 further shows a reel of images that have been clicked at a particular location. The user can visit that particular favorite location to click images. FIG. 10C represents a user-interface 1003 of a preview of the camera application. Further FIG. 10D depicts a user-interface 1004 representing a screenshot of a preview of the camera application including a reel of reference photos that appear on the camera application when a user previews a location as shown in FIG. 10C.

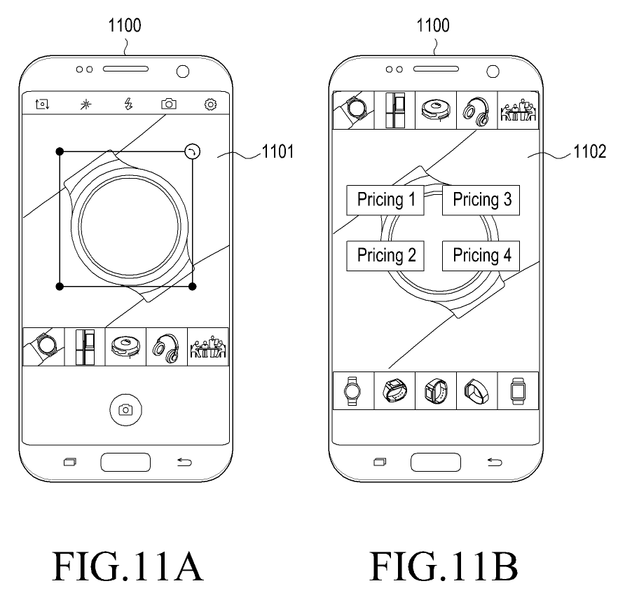

FIGS. 11A and 11B are views illustrating a camera application is being invoked while executing an e-commerce application, and contextual service related to the e-commerce application being rendered on a preview of the camera application based on the content of the camera application, according to an exemplary embodiment. Referring to FIG. 11A, a user-interface 1101 of the device 1100 depicts a screenshot of a preview of a camera application. Further, the user can tap an object on the preview screen of the camera application for which he desires to view deals and suggestions. Referring to FIG. 11B, a user-interface 1102 of the device 1100 depicts a screenshot of a preview of a camera application with contextual information in a form of deals and suggestions for the object shown in the preview screen of the camera application. Further, the contextual information i.e., deals and suggestions, are rendered or overlaid over the preview screen of the camera application that was shown in the user-interface 1101 in FIG. 11A. Such contextual information is provided as live information by the e-commerce application running in a background on the device 1100.

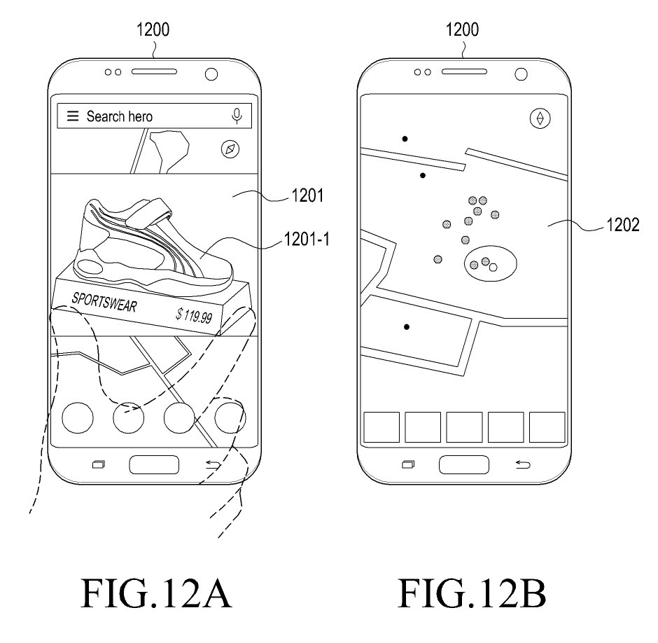

FIGS. 12A and 12B are views illustrating a camera application being invoked from a non-camera application to view a suggested location to buy a product or an object being previewed or captured by the camera application, according to an exemplary embodiment. By way of an example, while shopping at a market place, the user can invoke a camera application on his device while viewing a navigation application. Referring to FIG. 12A, a user-interface 1201 of the device 1200 depicts a screenshot of the camera application being invoked from a navigation application. As represented in FIG. 12A, a “shoe” object 1201-1 is being previewed in the camera application. The navigation application provides contextual information in the form of suggested stores which the user can visit to buy the object, “shoe”. Referring to FIG. 12B, a user-interface 1202 of the device 1200 depicts a screenshot of the navigation application including contextual information such as a location of the suggested stores for the user to visit.

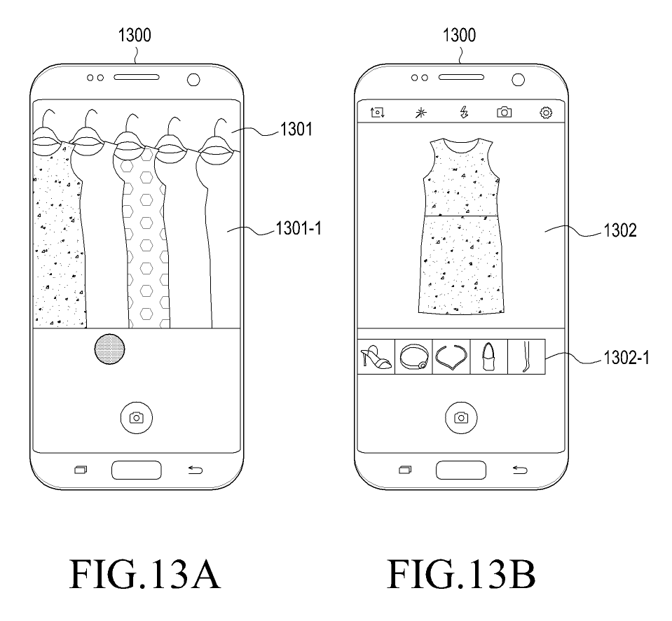

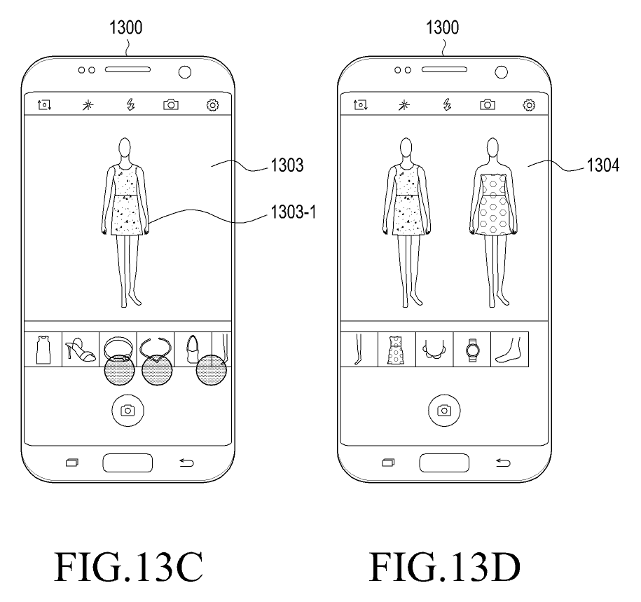

By way of a further example, the contextual information being provided by an e-commerce application can include graphical objects related to a product being previewed on a camera application. Further, the contextual information is supplemented with a virtual mannequin on which one or more action can be auto-performed on selecting the graphical objects appearing on the reel of the camera application, according to an exemplary embodiment. Referring to FIG. 13A, a user-interface 1301 of the device 1300 depicts a screenshot of a preview screen of the camera application including “clothes” object 1301-1. Referring to FIG. 13B, a user-interface 1302 of the device 1300 depicts a screenshot of a preview of the camera application including graphical representations in the reel 1302-1, the graphical representations are related to the “clothes” object 1301-1 as shown in FIG. 13A. Referring to FIG. 13C, a user-interface 1303 of the device 1300 depicts a screenshot of a preview screen of the camera application including a mannequin 1303-1 appearing with similar “clothes” object as shown in FIG. 13A. The graphical objects also appear in the reel of the camera preview as shown in FIG. 13C. According to an exemplary embodiment, a user can auto-perform actions on the mannequin by selecting the desired graphical representations which will then appear at the designated places on the mannequin. Referring to FIG. 13D, a user-interface 1304 of the device 1300 depicts a screenshot of a preview screen of the camera application including two mannequins. According to an exemplary embodiment, the user can compare two looks of the mannequin appearing with two different “clothes” object for the user to compare and make a choice.

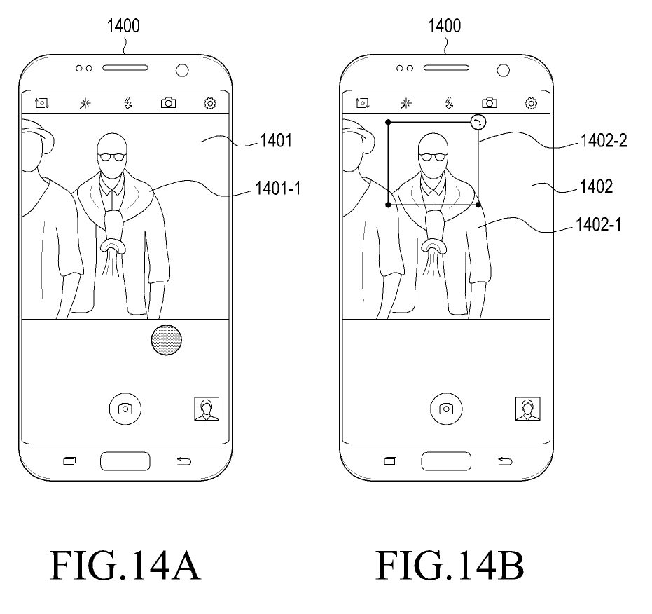

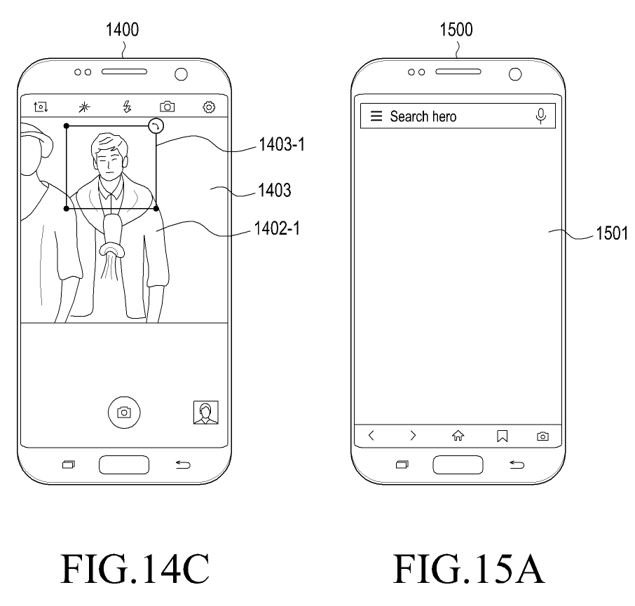

FIGS. 14A-14C are views illustrating contextual information being supplemented with one or more user-selectable actions to be performed on a preview screen of the camera application according to an exemplary embodiment. Referring to FIG. 14A, a user-interface 1401 of the device 1400 depicts a screenshot of a preview of a camera application including a live view of mannequins 1401-1 wearing clothes. Referring to FIG. 14B, a user-interface 1402 of the device 1400 depicts a screenshot of a preview of a camera application including a live view of mannequins 1402-1 wearing clothes and a selected portion 1402-2 of the image being previewed which the user wants to swap with his own image. According to an exemplary embodiment, when receiving the user-selectable action to swap a portion of the image being previewed on a rear-view of the camera application, the portion is swapped with an image being previewed from a front-view of the camera application. By way of an example, FIG. 14C depicts a user-interface 1403 of the device 1400, where the user-interface 1403 depicts a rear-preview of the camera application wherein a portion 1403-1 has been swapped with an image being previewed on a front-preview of the camera application.

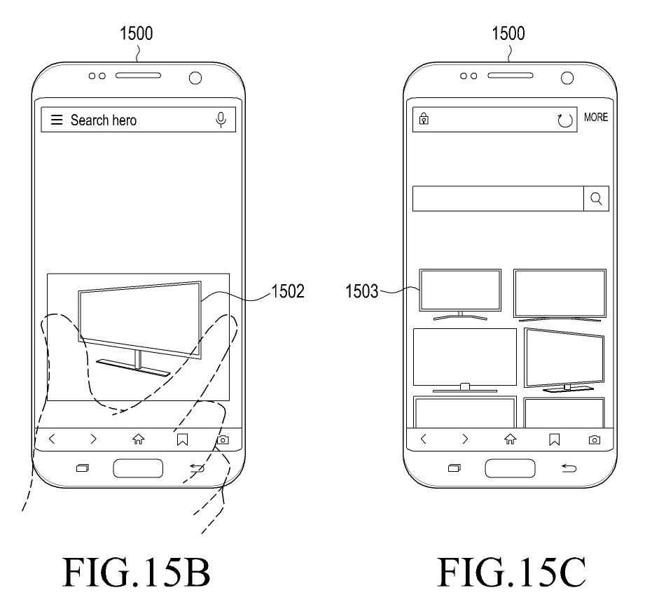

FIGS. 15A-15C are views illustrating a camera application being invoked from a search application according to an exemplary embodiment. Referring to FIG. 15A, a user-interface 1501 of the device 1500 depicts a screenshot of a search application. Referring to FIG. 15B, a user-interface 1502 of the device 1500 depicts a screenshot of a preview of a camera application being invoked from a search application by a bezel-swipe on a screen of the search application or while running the search application. Referring to FIG. 15C, a user-interface 1503 of the device 1500 depicts a screenshot of the search application including search results related to the product being previewed in the camera application, as shown in FIG. 15B.

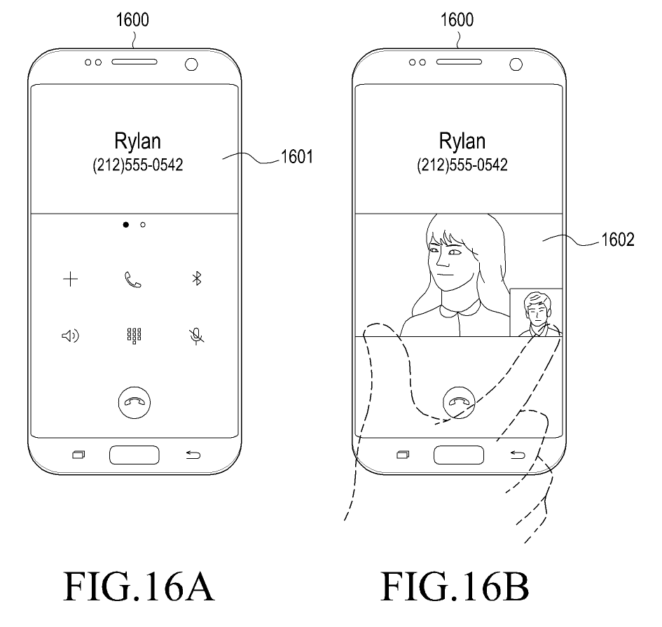

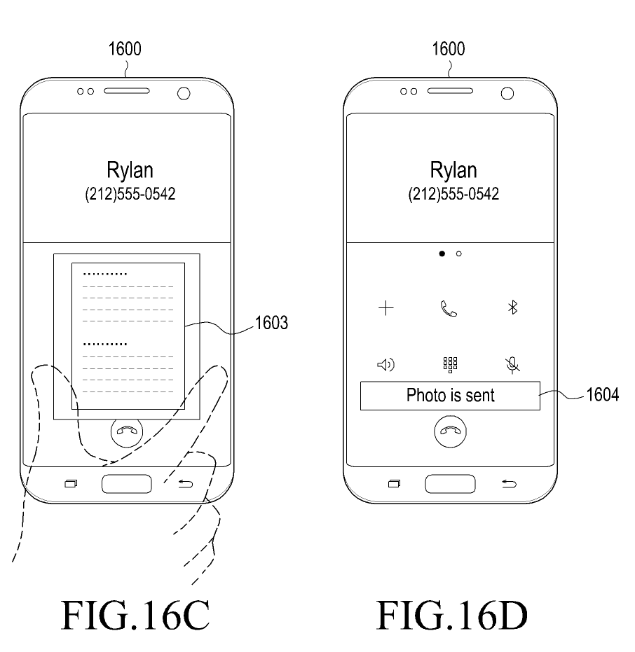

FIGS. 16A-16D are views illustrating a camera application being invoked from a calling application according to an exemplary embodiment. Referring to FIG. 16A, a user-interface 1601 of the device 1600 depicts a screenshot of a calling application executed on the device 1600. By way of an example, the calling application can be converted to a video call by invoking a camera application within the calling application. Referring to FIG. 16B, a user-interface 1602 of the device 1600 depicts a screenshot of a camera application being invoked from the calling application running on the device 1600 by performing a rail-bezel swipe on the device 1600. As shown in FIG. 16B, the invoking of the camera application results in invoking of a front preview of the camera application resulting in a video call. Further, by way of an example, an image can be shared by performing a user-actionable action to share a document with the calling application, while an ongoing call is in progress using the device 1600. Referring to FIG. 16C, a user-interface 1603 of the device 1600 depicts a screenshot of a camera application being invoked over the calling application on the device 1600 by performing a rail-bezel swipe on the device 1600. As shown in FIG. 16C, the invoking of the camera application results in invoking of a rear-preview of the camera application resulting in an image to appear on a screen of the calling application, which depicts sharing of the image with the called party through the device 1600. Referring to FIG. 16D, a user-interface 1604 of the device 1600 depicts a screenshot of the calling application including an indication that the image has been sent.

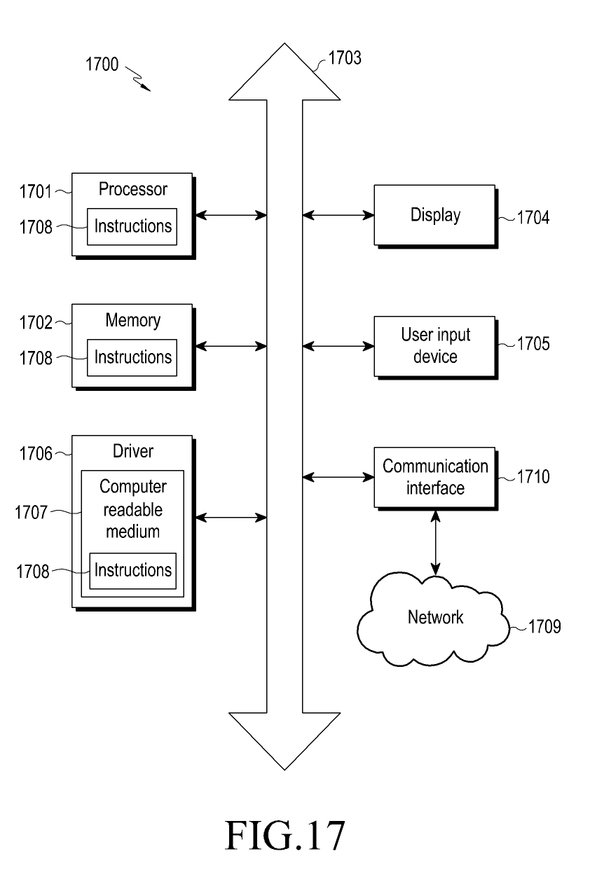

FIG. 17 is a block diagram illustrating a hardware configuration of a computing device 1700, which is representative of a hardware environment for implementing the method as disclosed in FIG. 1, according to an exemplary embodiment. As would be understood, the device 200, as described in FIG. 2 above, and the device 300, as described in FIG. 3 above, includes the hardware configuration as described below, according to an exemplary embodiment.

In a networked deployment, the computing device 1700 may operate in the capacity of a server or as a client user computer in a server-client user network environment, or as a peer computer system in a peer-to-peer (or distributed) network environment. The computing device 1700 can also be implemented as or incorporated into various devices, such as, a tablet, a personal digital assistant (PDA), a palmtop computer, a laptop, a smart phone, a notebook, and a communication device.

The computing device 1700 may include a processor 1701 e.g., a central processing unit (CPU), a graphics processing unit (GPU), or both. The processor 1701 may be a component in a variety of systems. For example, the processor 1701 may be part of a standard personal computer or a workstation. The processor 1701 may be one or more general processors, digital signal processors, application specific integrated circuits, field programmable gate arrays, servers, networks, digital circuits, analog circuits, combinations thereof, or other now known or later developed devices for analyzing and processing data. The processor 1701 may implement a software program, such as code generated manually (i.e., programmed).

The computing device 1700 may include a memory 1702 communicating with the processor 1701 via a bus 1703. The memory 1702 may be a main memory, a static memory, or a dynamic memory. The memory 1702 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 1702 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1702 is operable to store instructions executable by the processor 1701. The functions, acts or tasks illustrated in the figures or described may be performed by the programmed processor 1701 executing the instructions stored in the memory 1702. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computing device 1700 may further include a display unit 1704, such as a liquid crystal display (LCD), an organic light emitting diode (OLED), a flat panel display, a solid state display, a cathode ray tube (CRT), or other now known or later developed display device for outputting determined information.

Additionally, the computing device 1700 may include a user input device 1705 configured to allow a user to interact with any of the components of the system 1700. The user input device 1705 may be a number pad, a keyboard, a stylus, an electronic pen, or a cursor control device, such as a mouse, or a joystick, touch screen display, remote control or any other device operative to interact with the computing device 1700.

The computing device 1700 may also include a disk or optical driver 1706. The driver 1706 may include a computer-readable medium 1707 in which one or more sets of instructions 1708, e.g. software, can be embedded. In addition, the instructions 1708 may be separately stored in the processor 1701 and the memory 1702.

The computing device 1700 may further be in communication with other device over a network 1709 to communicate voice, video, audio, images, or any other data over the network 1709. Further, the data and/or the instructions 1708 may be transmitted or received over the network 1709 via a communication port or interface 1710 or using the bus 1703. The communication port or interface 1710 may be a part of the processor 1701 or may be a separate component. The communication port 1710 may be created in software or may be a physical connection in hardware. The communication port or interface 1710 may be configured to connect with the network 1709, external media, the display 904, or any other components in system 1700 or combinations thereof. The connection with the network 1709 may be a physical connection, such as a wired Ethernet connection or may be established wirelessly as discussed later. Likewise, the additional connections with other components of the computer device 1700 may be physical connections or may be established wirelessly. The network 1709 may alternatively be directly connected to the bus 1703.

The network 1709 may include wired networks, wireless networks, Ethernet AVB networks, or combinations thereof. The wireless network may be a cellular telephone network, an 802.9, 802.16, 802.20, 802.1Q or WiMax network. Further, the network 909 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the device 1700.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computing device 1700 may be implemented by software programs executable by the processor 1701. Further, in a non-limited example, implementations can include distributed processing, component/object distributed processing, and parallel processing. Alternatively, virtual computer system processing can be constructed to implement various parts of the system.

The computing device 1700 is not limited to operation with any particular standards and protocols. For example, standards for Internet and other packet switched network transmission (e.g., TCP/IP, UDP/IP, HTML, HTTP, etc.) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of various embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of exemplary embodiments is not limited by these specific examples. Numerous variations, whether explicitly given in the specification or not, such as differences in structure, dimension, and use of material, are possible. The scope of exemplary embodiments is at least as broad as given by the following claims and their equivalents.

While certain exemplary embodiments have been illustrated and described herein, it is to be understood that the disclosure is not limited thereto. Clearly, the disclosure may be otherwise variously embodied, and practiced within the scope of the following claims and their equivalents.

What is claimed is:

1. A method of providing contextual information comprising:
detecting an invocation of a camera application via a user-input while executing a non-camera application by a device;
identifying content from at least one of:
a preview of the camera application, and
a multi-media captured by the camera application;
identifying the contextual information based on at least one of:
the identified content, and
information available from the non-camera application; and
sharing the identified contextual information between the camera application and the non-camera application.

2. The method as claimed in claim 1, further comprising:
performing, by the camera application of the device, at least one operation from among a plurality of operations, within the non-camera application,
wherein the plurality of operations comprise at least one of:
a preview operation;
the preview operation in an augmented reality view;
a preview adjusting operation;
a multi-media capturing operation;
a virtual object adding operation;
an augmented multi-media adding operation;
a multi-media capturing operation in an omni-directional view;
a multi-media capturing operation the augmented reality view; and
a location tagging operation.

3. The method as claimed in claim 2, wherein the identified contextual information is identified based on the content comprising at least one of:
captured multi-media;
an added virtual object;
augmented multi-media; and
a location tagged data.

4. The method as claimed in claim 1, further comprising:
providing the identified contextual information at least one designated position on a screen of the non-camera application.

5. The method as claimed in claim 4, further comprising:
overlaying the identified contextual information on the identified content of the camera application,
wherein the camera application being invoked in the non-camera application executed by the device.

6. The method as claimed in claim 3, further comprising:
storing, in a database, the identified contextual information.

7. The method as claimed in claim 6, further comprising:
providing the identified contextual information, which is identified based on the identified content, to the other devices while executing one of:
a camera application;
a camera application invoked in a non-camera application; and
an augmented reality application.

8. The method as claimed in claim 1, wherein the identifying the contextual information comprises identifying the contextual information based on the information available from the non-camera application,
wherein the identified contextual information comprises at least one of:
at least one pre-captured multi-media,
pre-designated augmented multi-media,
a pre-designated virtual object,
at least one suggested location, and
geo-tagged data,
wherein the identified contextual information is based on a geographic location detected from the identified content, and
wherein the non-camera application is one of a navigation application and a location based application.

9. The method as claimed in claim 8, further comprising:
providing the identified contextual information on a display of the device based on a rank of the identified contextual information in relation to a distance range measured from the device,
wherein the distance range corresponds to a moving speed of the device.

10. The method as claimed in claim 1, wherein the identifying the contextual information comprises identified the contextual information based on the information available from the non-camera application,
wherein the identified contextual information comprises at least one of:
at least one recommended products based on at least one products identified from the content;
pricing information associated with the at least one recommended product;
a modified content based on at least one auto performed action in the content;
search results comprising multi-media or textual information related to products substantial similar to the at least one product identified from the content; and
a plurality of suggested locations, and
wherein the non-camera application is one of an e-commerce application and a search application.

11. The method as claimed in claim 1, further comprising:
displaying, by a display of the device, the identified contextual information within one of a preview screen and a multi-media screen of the camera application within a user interface of the non-camera application.

12. The method as claimed in claim 1, wherein the non-camera application is a calling application,
wherein the contextual information comprises one of:
a front preview of the camera application,
a rear preview of the camera application, and
an image captured by the camera application,
wherein the identified contextual information is provided within the calling application during an ongoing calling operation by the device.

13. The method as claimed in claim 1, further comprising:
displaying, on a display, a user-interface within the non-camera application,
wherein the displayed user-interface comprises a plurality of user-actionable items comprising at least one of a content sharing action and a content searching action.

14. The method as claimed in claim 1, wherein the non-camera application is one of a navigation application, a location-based application, an e-commerce application, a searching application, a calling application, and a music and a video application.

15. An apparatus for providing contextual information comprising:
a memory which stored a plurality of instructions; and
a processor which executes the stored instructions, which when executed by the processor, cause the processor to:
detect an invocation of a camera application via a user-input while executing a non-camera application by the processor;
identify content from at least one of:
a preview of the camera application, and
multi-media captured by the camera application;
identify the contextual information based on at least one of:
the identified content, and
information available from the non-camera application; and
share the identified contextual information between the camera application and the non-camera application.

16. The apparatus as claimed in claim 15, wherein the contextual information comprises at least one of:
multi-media captured via the camera application,
a virtual object captured via the camera application,
augmented multi-media captured via the camera application,
location tagged data captured via the camera application,
at least one pre-captured multi-media,
pre-designated augmented multi-media,
a pre-designated virtual object,
at least one suggested location,
geo-tagged data,
at least one recommended product based on at least one product identified in the content,
pricing information associated with the at least one recommended product,
a modified content based on at least one auto performed action on the identified content, and
search results comprising multi-media or textual information pertaining to at least one other product substantially similar to the at least one recommended product.

17. The apparatus as claimed in claim 15, wherein the sharing of the identified contextual information comprises providing the identified contextual information at at least one designated position on a screen of the non-camera application.

18. The apparatus as claimed in claim 15, wherein the sharing of the identified contextual information comprises providing the identified contextual information on the identified content of the camera application,
wherein the camera application is invoked from the non-camera application, by the device.

19. The apparatus as claimed in claim 15, wherein the sharing of the identified contextual information comprises providing the identified contextual information within one of a preview and a multi-media, captured by the camera application, while executing the non-camera application, by the device.

20. The apparatus as claimed in claim 15, wherein the memory has a database which stores the identified contextual information based on the identified content, for use in augmented reality on other devices.
